(19) United States
(12) Patent Application Publication
(10) Pub. No.: US 2010/0121698 A1
(43) Pub. Date: May 13, 2010

(54) CUSTOMER INCENTIVE SYSTEM BASED ON AN EXTERNAL LOTTERY DRAWING

(76) Inventor: Michael Luzbet, Miami, FL (US)

Correspondence Address: FELDMAN GALE, P.A., 1700 Market Street, Suite 3130, Philadelphia, PA, 19103, US

(21) Appl. No.: 12/693,068

(22) Filed: Jan. 25, 2010

Related U.S. Application Data
(63) Continuation-in-part of application No. 12/191,690, filed on Aug. 14, 2008.
(60) Provisional application No. 60/956,048, filed on Aug. 15, 2007.

(51) Int. Cl. G06Q 30/00; G06Q 50/00

(52) U.S. Cl. 705/14.14

(57) ABSTRACT

A method of providing customer incentives to a business wherein a buyer of real and/or personal property negotiates the price of the property with the seller, and upon reaching a satisfactory price, the seller shall provide the buyer with a series of numbers prior to transferring title in the property.

### CROSS-REFERENCE TO RELATED APPLICATIONS

This application is a continuation-in-part of U.S. patent application Ser. No. 12/191,690, filed Aug. 14, 2008, which is incorporated herein by reference and which claims the priority benefit under 35 U.S.C. §119(e) of U.S. Provisional Application No. 60/956,048 filed Aug. 15, 2007, the complete disclosure of which is incorporated herein by reference in its entirety.

### FIELD OF THE INVENTION

The present invention generally relates to a method of providing a customer incentives for businesses.

### DETAILED DESCRIPTION OF THE DRAWINGS

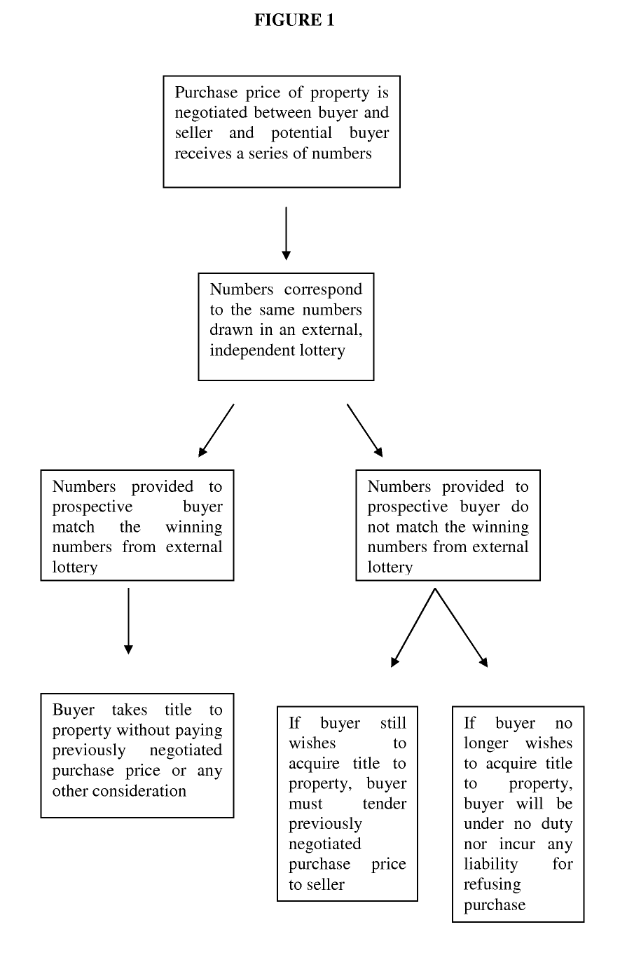

FIG. 1 depicts a flow chart of a preferred embodiment of the present invention.

### DETAILED DESCRIPTION OF THE PREFERRED EMBODIMENTS

A method of providing customer incentives to a business wherein a customer (defined herein as a “buyer”) of real and/or personal property negotiates the price of the property with the seller, and upon reaching a satisfactory price, the seller shall provide the buyer with one or more numbers prior to transferring title in the property. Alternatively, the series of numbers can be a series of letters or other symbols or characters. The numbers are preferably provided to the buyer through a dispensing machine that randomly generates the one or more numbers.

Each negotiation between buyer and seller for real and/or personal property shall correspond to an external and independent lottery drawing so that if the one or more numbers provided by the seller to the buyer match the same series of winning numbers randomly selected by the corresponding lottery drawing, the buyer may take title to the previously negotiated real and/or personal property without paying the negotiated purchase price or any other amount of consideration.

If the one or more numbers randomly selected by the corresponding lottery drawing do not correspond to the one or more numbers provided by the seller to the buyer, the buyer may only receive title to the real and/or personal property by tendering the previously negotiated purchase price to the seller.

In another embodiment, if the one or more numbers randomly selected by the corresponding lottery drawing do not correspond to the one or more numbers provided by the seller to the buyer, the buyer will be under no obligation to purchase the real and/or personal property, and shall incur no liability for declining to purchase to the real and/or personal property.

The following are prophetic examples of the present invention.

### Example 1

A potential buyer approaches a used car salesman and negotiates a purchase price with the salesman for the title to a particular used car. After the buyer and seller agree on a satisfactory purchase price, the salesman provides the buyer with a series of three numbers. The three numbers can be selected randomly or, in another embodiment, the three numbers can be selected from the last three digits of the buyer's driver's license number. Preferably, the numbers are provided to the buyer through a dispensing machine capable of interacting with the buyer. The dispensing machine is preferably located at the seller's place of business. If the three numbers provided to the buyer by the salesman match the same three numbers selected in the Florida Lotto's™ next Cash 3™ drawing, the buyer is free to take title in the previously negotiated used car without paying the salesman the purchase price (or any other amount of consideration) for the car. If the three numbers provided to the buyer by the salesman do not match the same three numbers selected in the Florida Lotto's™ next Cash 3™ drawing, the buyer can only take title to the car by tendering the negotiated purchase price of the car to the salesman. If, however, the buyer decides not to purchase the car, the buyer shall be under no obligation, nor incur any liability for declining to purchase the car.

### Example 2

A potential buyer approaches a residential real estate broker and/or seller and negotiates a purchase price with the broker/seller for a particular piece of residential real property. After the buyer and broker/seller agree on a satisfactory purchase price, the broker/seller provides the buyer with a series of four numbers. Preferably, the numbers are provided to the buyer through a dispensing machine. The dispensing machine is preferably located at the seller's place of business. The four numbers can be selected randomly or, in another embodiment, the four numbers can be selected from the last four digits of the buyer's social security number. If the four numbers provided to the buyer by the broker/seller match the same four numbers selected in the Florida Lotto's™ next Play 4™ drawing, the buyer is free to take title in the previously negotiated real property without paying the broker/seller the purchase price (or any other amount of consideration) for the real property. If the four numbers provided to the buyer by the broker/seller do not match the same four numbers selected in the Florida Lotto's™ next Play 4™ drawing, the buyer can only take title to the real property by tendering the negotiated purchase price of the real property to the broker/seller. If, however, the buyer decides not to purchase the real property, the buyer shall be under no obligation, nor incur any liability for declining to purchase the real property.

### Example 3

A buyer enters a local grocery store and prior to purchasing any groceries, the buyer either receives a free preprinted ticket with a series of one or more numbers from the local grocery store, or alternatively, the buyer selects one or more numbers which are subsequently printed on a ticket that is provided to the buyer. Preferably the ticket is provided to the buyer through a dispensing machine located in the grocery store. After purchasing his or her groceries, a monitor or similar display device will subsequently show the buyer a series of numbers that have been independently and externally selected from the one or more numbers either initially chosen by the buyer or initially provided to the buyer through the local grocery store's on-site dispensing machine. If the numbers provided to the buyer (either through the buyer's own selection or through the pre-printed method described above) match the same numbers displayed by the monitor or similar electronic display device, the buyer is either reimbursed or credited the purchase price of the groceries that were purchased.

1. A method of providing customer incentives to a business comprising the following steps:
negotiating the sale price of property between a buyer and a seller;
providing the buyer with a series of characters prior to transferring title in the property wherein said series of numbers correspond to a lottery drawing;
providing said characters to buyer through a dispensing machine capable of interacting with the buyer; and
awarding the buyer title to the previously negotiated property if said series of characters match said corresponding, lottery drawing.

2. The method of claim 1 wherein said property is personal property.

3. The method of claim 1 wherein said property is real property.

4. The method of claim 1 wherein said characters are numbers.

5. The method of claim 1 further comprising the step of displaying the results of said corresponding, lottery drawing on an electronic display device.

6. The method of claim 1 wherein said lottery drawing is an independent or external lottery drawing.

7. The method of claim 1 further comprising the step of permitting the buyer to decline the purchase of said property if said series of characters do not match said corresponding, lottery drawing.
